(19) United States
(12) Patent Application Publication
(10) Pub. No.: US 2022/0258646 A1
(43) Pub. Date: Aug. 18, 2022

(54) BATTERY INFORMATION MANAGEMENT DEVICE, BATTERY INFORMATION MANAGEMENT METHOD, AND BATTERY INFORMATION MANAGEMENT SYSTEM

(71) Applicant: Panasonic Intellectual Property Management Co., Ltd., Osaka (JP)

(72) Inventors: Takuma IIDA, KANAGAWA KEN (JP); Takayuki IWASAKI, KANAGAWA KEN (JP); Masaaki HOSHIDA, FUKUOKA KEN (JP)

(73) Assignee: Panasonic Intellectual Property Management Co., Ltd., Osaka (JP)

(21) Appl. No.: 17/737,735

(22) Filed: May 5, 2022

Related U.S. Application Data
(63) Continuation of application No. PCT/JP2020/027570, filed on Jul. 15, 2020.

(30) Foreign Application Priority Data
Nov. 29, 2019 (JP) 2019-217437

(51) Int. Cl. B60L 58/16; B60L 3/00; H01M 10/48

(52) U.S. Cl. CPC B60L 58/16; H01M 10/48; B60L 3/0046

(57) ABSTRACT

A battery information management device according to the present disclosure includes a memory, and a hardware processor coupled to the memory. The hardware processor being configured to: when a degree of deterioration of a battery is lower than a reference, collect battery information on the battery with a first collection period; when the degree of deterioration of the battery is equal to or higher than the reference, collect the battery information with a second collection period shorter than the first collection period; and transmit the collected battery information to an external device.

### CROSS-REFERENCE TO RELATED APPLICATIONS

This application is a continuation of International Application No. PCT/JP2020/027570, filed on Jul. 15, 2020 which claims the benefit of priority of the prior Japanese Patent Application No. 2019-217437, filed on Nov. 29, 2019, the entire contents of which are incorporated herein by reference.

### FIELD

The present disclosure relates to a battery information management device, a battery information management method, and a battery information management system.

### BACKGROUND

Conventionally, technologies for collecting information on, for example, the voltage, the current, or the temperature of a battery every certain period to monitor the state of the battery have been used.

A conventional technique is described in Japanese Patent Application Laid-open No. 2012-112811.

The present disclosure provides a battery information management device, a battery information management method, and a battery information management system, each being capable of reducing the volume of data traffic associated with battery management.

### SUMMARY

A battery information management device according to the present disclosure includes a memory, and a hardware processor coupled to the memory. The hardware processor being configured to: when a degree of deterioration of a battery is lower than a reference, collect battery information on the battery with a first collection period; when the degree of deterioration of the battery is equal to or higher than the reference, collect the battery information with a second collection period shorter than the first collection period; and transmit the collected battery information to an external device.

### BRIEF DESCRIPTION OF THE DRAWINGS

FIG. 1 is a diagram illustrating an example of the overall configuration of a battery information management system according to a first embodiment;

FIG. 2 is a diagram illustrating an example of a configuration including a battery management unit (BMU), a cell monitoring unit (CMU), and a battery according to the first embodiment;

FIG. 3 is a diagram illustrating an example of the functional configuration of the BMU according to the first embodiment;

FIG. 4 is a diagram illustrating an example of an equivalent circuit model of the battery according to the first embodiment;

FIG. 5 is a diagram illustrating an example of the functional configuration of an electronic control unit (ECU) according to the first embodiment;

FIG. 6 is a flowchart illustrating an example of the flow of processing executed in the BMU according to the first embodiment;

FIG. 7 is a flowchart illustrating an example of the flow of processing executed in the ECU according to the first embodiment;

FIG. 8 is a diagram illustrating an example of a configuration including a BMU and a battery according to a second embodiment;

FIG. 9 is a diagram illustrating an example of the functional configuration of an ECU according to a third embodiment; and

FIG. 10 is a diagram illustrating an example of a storage format of battery information and the state of a vehicle according to the third embodiment.

### DETAILED DESCRIPTION

Hereinafter, embodiments of a battery information management device, a battery information management method, and a battery information management system according to the present disclosure will be described with reference to the drawings.

### First Embodiment

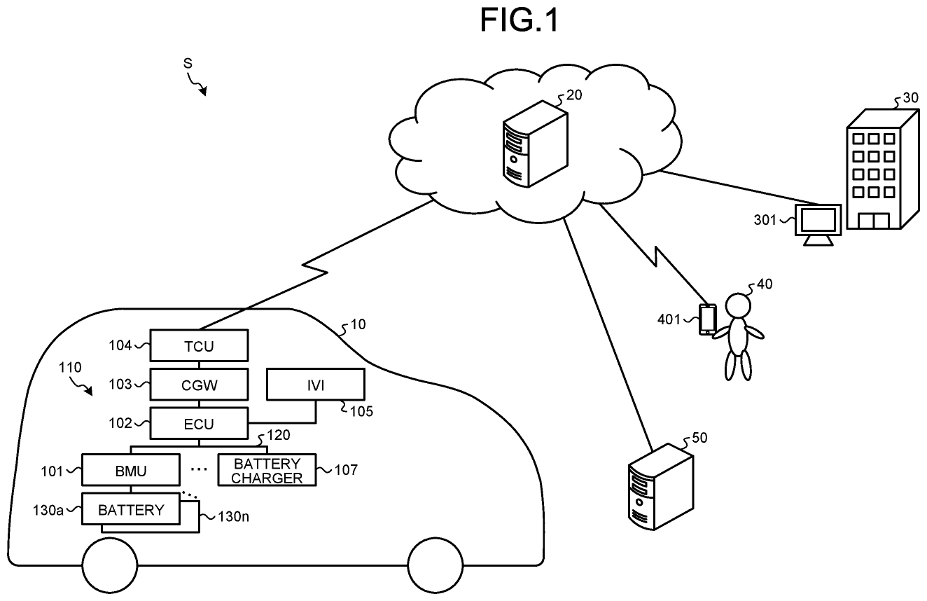

FIG. 1 is a diagram illustrating an example of the overall configuration of a battery information management system S according to the present embodiment. The battery information management system S includes an electronic control unit (ECU) 102 and a battery management unit (BMU) 101 that are installed in a vehicle 10, and a cloud server device 20. The battery information management system S may further include constituents included in a vehicle control system 110 installed in the vehicle 10, other than the ECU 102 and the BMU 101. The battery information management system S may further include, for example, a delivery terminal 301 provided in a delivery company 30, an information processing terminal 401 owned by a user 40, or a server device 50.

The cloud server device 20 is a server device formed in a cloud environment. The cloud server device 20 functions as a storage device configured to store information on a battery 130 transmitted from the vehicle 10. The cloud server device 20 may be, for example, configured with one server device or configured with a plurality of server devices connected to the Internet. Furthermore, the cloud server device 20 transmits information on the battery 130 to the delivery terminal 301, the information processing terminal 401, or the server device 50.

The delivery company 30 is, for example, a company that delivers goods using the vehicle 10 in the case where the vehicle 10 is a business-use delivery van. The delivery terminal 301 is, for example, a personal computer (PC) or a tablet terminal provided in the delivery company 30. The delivery terminal 301 is connected to the cloud server device 20 via a wireless or wired network to receive information on the battery 130 of the vehicle 10 from the cloud server device 20.

The user 40 is, for example, an owner or a user of the vehicle 10 in the case where the vehicle 10 is a vehicle for private use or a car-sharing vehicle. The information processing terminal 401 is, for example, a smartphone, and is connected to the cloud server device 20 via a wireless or wired network to receive information on the battery 130 of the vehicle 10 from the cloud server device 20.

The server device 50 is, for example, a server device owned by a service company that provides information on the vehicle 10. The server device 50 is connected to the cloud server device 20 via a wireless or wired network to receive information on the battery 130 of the vehicle 10 from the cloud server device 20. Furthermore, the server device 50 transmits information based on the received information on the battery 130 to other devices.

Note that the delivery terminal 301, the information processing terminal 401, and the server device 50 are merely examples of a communication destination for the cloud server device 20, and the communication destination for the cloud server device 20 is not limited to these examples.

The vehicle 10 is an electric vehicle driven by the electric power of the battery 130.

The vehicle control system 110 includes, for example, a telematics control unit (TCU) 104, a central gateway (CGW) 103, the ECU 102, an in-vehicle infotainment (IVI) 105, the BMU 101, a plurality of batteries 130a to 130n, and a battery charger 106. These constituents are connected via an in-vehicle network 120. The in-vehicle network 120 is, for example, a controller area network (CAN). The configuration illustrated in FIG. 1 is merely an example, and the vehicle control system 110 may further include other constituents.

In the vehicle control system 110, all the constituents may be connected to one in-vehicle network 120 or may be divided and respectively connected to in-vehicle networks having their respective channels.

The ECU 102 is, for example, a vehicle control unit (VCU) configured to control the entirety of the vehicle 10. The ECU 102 transmits battery information acquired from the BMU 101 to the cloud server device 20 via the CGW 103 and the TCU 104. The ECU 102 is an example of a control device in the present embodiment.

The TCU 104 executes wireless communications with an external device. In the present embodiment, the TCU 104 executes wireless communications with the cloud server device 20.

The CGW 103 relays data communications between the ECU 102 and the outside.

The IVI 105 is a system that provides a car navigation function or an in-vehicle entertainment function such as a car audio. The IVI 105 controls a monitor and a loudspeaker that are installed in the vehicle 10.

Each of the batteries 130a to 130n is a rechargeable secondary battery to supply electric power for driving the vehicle 10. In the present embodiment, in the case of not distinguishing the batteries 130a to 130n from each other, the batteries are simply referred to as the battery 130. The type of the battery 130 is not limited to a particular type, and the battery 130 may be, for example, a lithium-ion battery or a nickel-hydride battery. The battery 130 is an example of a battery in the present embodiment.

The battery charger 106 charges the battery 130. The battery charger 106 chares, for example, the battery 130 with electric power supplied from the outside of the vehicle 10 or regenerative power.

The BMU 101 monitors the state of the battery 130 and transmits a monitoring result to the ECU 102 via the in-vehicle network 120. The BMU 101 is also referred to as a battery management system (BMS).

The BMU 101 is an example of a battery information management device in the present embodiment. The BMU 101 is, for example, a computer including a microcontroller. The microcontroller includes, for example, a processor, a memory, such as a random access memory (RAM) or a read only memory (ROM), an input/output circuit, and a timer circuit. Note that the constituents of the BMU 101 are not limited to them.

The BMU 101 collects battery information on the battery 130. The battery information includes various measured values, such as a voltage, a current, a temperature, and an internal resistance of the battery 130. Furthermore, the BMU 101 calculates the state of health (SOH) of the battery and the state of charge (SOC) from the various measured values.

In the present embodiment, the SOH is the percentage of a current full-charge capacity (Ah) to an initial full-charge capacity (Ah). When a SOH value is closer to 100%, the degree of deterioration is lower. Note that a technique for calculating the SOH is not limited to this and may be calculated from a resistance value. Furthermore, in the present embodiment, the SOC is the percentage of a remaining capacity (Ah) to a full-charge capacity (Ah).

The battery information in the present embodiment further includes calculated values, such as a SOH and a SOC, and alternative characteristics estimated from measured values such as the presence of dry-up in the battery 130. Although the battery information is not limited to these items, the battery information shall include at least one of a voltage, a current, and a temperature.

More specifically, the BMU 101 acquires various measured values from a cell monitoring unit (CMU) installed in each of the batteries 130.

In the present embodiment, the expression “collecting battery information” means both the acquisition of information on a battery by the BMU 101 from the outside and the calculation or estimation of information on the battery by the BMU 101, based on the information acquired from the outside.

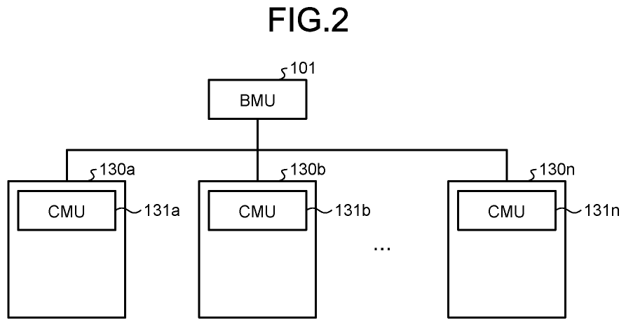

FIG. 2 is a diagram illustrating an example of a configuration including the BMU 101, the CMUs 131a to 131n, and the batteries 130a to 130n according to the present embodiment.

As illustrated in FIG. 2, each of the CMUs 131a to 131n is provided in a corresponding one of the batteries 130a to 130n. Hereinafter, in the case where the CMUs 131a to 131n are not individually distinguished, the CMUs 131a to 131n are simply referred to as the CMU 131. The CMU 131 includes various sensors configured to measure the state of the battery 130, such as a current sensor, a voltage sensor, and a temperature sensor. These sensors may be provided outside the CMU 131, and the CMU 131 may acquire measured values from these sensors.

The CMU 131 measures the voltage, current, or temperature of the battery 130, under the control of the BMU 101. Furthermore, the CMU 131 transmits measurement results to the BMU 101.

Note that, although the configuration illustrated in FIG. 2 in which the batteries 130 are connected in parallel is described as an example, the number of the batteries 130 may be one.

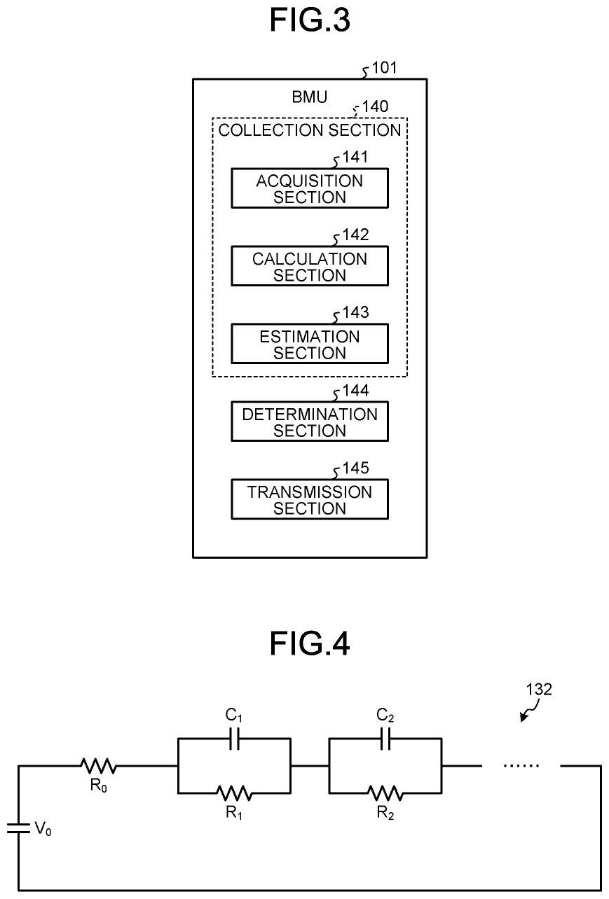

Next, details of functions of the BMU 101 according to the present embodiment will be described. FIG. 3 is a figure illustrating an example of the functional configuration of the BMU 101 according to the present embodiment.

As illustrated in FIG. 3. the BMU 101 includes an acquisition section 141, a calculation section 142, an estimation section 143, a determination section 144, and a transmission section 145.

For example, the acquisition section 141, the calculation section 142, the estimation section 143, the determination section 144, and the transmission section 145 are stored and provided in a memory of the BMU 101, as computer programs in a format executable by a computer. The processor of the BMU 101 reads out and executes the computer programs from the memory, thereby realizing functions corresponding to the above-mentioned sections.

Alternatively, the computer programs executed by the BMU 101 according to the present embodiment may be configured to be stored and provided in a computer-readable storage medium, such as a CD-ROM, a flexible disk (FD), a CD-R, or a digital versatile disc (DVD), as files in an installable or executable format.

Furthermore, the computer programs executed by the BMU 101 according to the present embodiment may be configured to be stored in a computer connected to a network, such as the Internet, and downloaded and provided via the network.

Alternatively, the computer programs executed by the BMU 101 according to the present embodiment may be configured to be provided or distributed via a network, such as the Internet.

Alternatively, the acquisition section 141, the calculation section 142, the estimation section 143, the determination section 144, and the transmission section 145 may be realized in a hardware circuit.

The acquisition section 141, the calculation section 142, and the estimation section 143 are correctively referred to as a collection section 140.

The collection section 140 collects battery information, based on a collection condition in accordance with the state of deterioration of the battery 130.

The collection condition defines as any one or both of a collection period for collecting battery information and the types of data included in the battery information. For example, in the present embodiment, the collection condition shall include both the definitions of the collection period and the types of data.

More specifically, in the present embodiment, in accordance with the degree of deterioration of the battery 130 or the presence of an abnormality in the battery 130, the collection period and the type of data included in battery information are changed. The change in the collection condition shall be executed by the later-described determination section 144.

For example, when the degree of deterioration of the battery 130 is lower than the reference, the collection section 140 collects battery information with a first collection period. In contrast, when the degree of deterioration of the battery 130 is equal to or higher than the reference, the collection section 140 collects battery information with a second collection period shorter than the first collection period. Furthermore, when the degree of deterioration of the battery 130 is lower than the reference, the collection section 140 collects a plurality of types of data defined as the collection condition. In contrast, when the degree of deterioration of the battery 130 is equal to or higher than the reference, the collection section 140 collects more types of data than when the degree of deterioration of the battery 130 is lower than the reference. The above-described functions are executed by the acquisition section 141, the calculation section 142, and the estimation section 143, which are included in the collection section 140. Details of the functions of the acquisition section 141, the calculation section 142, and the estimation section 143 will be described later.

Furthermore, in the present embodiment, when the degree of deterioration of the battery 130 is lower than the reference, the collection section 140 further changes the collection period and the types of data to be collected, in accordance with the presence of an abnormality in the battery 130. For example, when the degree of deterioration of the battery 130 is lower than the reference and the battery 130 is not in an abnormal state, the collection section 140 collects battery information with the first collection period. In contrast, when the battery 130 is in an abnormal state, the collection section 140 collects battery information with the second collection period shorter than the first collection period.

When the battery 130 is not in an abnormal state, the collection section 140 collects a plurality of types of data defined as the collection condition. In contrast, when the battery 130 is in an abnormal state, the collection section 140 collects more types of data than when the battery 130 is not in an abnormal state.

Alternatively, when the battery 130 is in an abnormal state, the collection section 140 changes the types of data to be collected. In this case, the number of the types of data to be collected by the collection section 140 when the battery 130 is in an abnormal state may not be larger than the number when the battery 130 is not in an abnormal state.

In the present embodiment, the presence of an abnormality in the battery 130 is determined by the later-described determination section 144.

Furthermore, details of the latest collection condition are stored by the determination section 144, for example, in the memory of the BMU 101. The storage of the collection condition in the memory by the determination section 144 is referred to as the setting of the collection condition. The acquisition section 141, the calculation section 142, and the estimation section 143, which are included in the collection section 140, shall read out the latest collection condition from the memory and execute processing in accordance with the collection condition.

The determination section 144 determines the collection condition in accordance with the state of deterioration in the battery 130. In the present embodiment, when the SOH calculated by the later-described calculation section 142 is equal to or higher than a threshold, the determination section 144 determines that the battery 130 has not deteriorated. In contrast, when the SOH is lower than the threshold, the determination section 144 determines that the battery 130 has deteriorated.

The threshold of the SOH is an example of the reference indicating the degree of deterioration in the battery 130. The threshold of the SOH is not limited to a particular value, but is set to 80%, for example. The threshold of the SOH is, for example, predetermined and stored in the memory of the BMU 101.

The case where the SOH is equal to or higher than the threshold means that the degree of deterioration in the battery 130 is lower than the reference. In contrast, the case where the SOH is lower than the threshold means that the degree of deterioration in the battery 130 is equal to or higher than the reference.

The determination section 144 may determine the presence of the deterioration, based on the average or median of the SOHs of the batteries 130, or may determine the presence of the deterioration, based on the lowest value among the SOHs of the batteries 130.

Furthermore, the determination section 144 determines whether or not the battery 130 is in an abnormal state, based on the battery information collected by the collection section 140. For example, when the temperature of the battery 130 is equal to or higher than a threshold, when an overvoltage of the battery 130 has occurred, when the battery 130 has been dried up, or when the voltage difference between the batteries 130 is equal to or higher than a threshold, the determination section 144 determines that the battery 130 is in an abnormal state.

For each of the batteries 130, the determination section 144 individually determines whether or not the temperature of the battery 130 is equal to or higher than the threshold, whether or not an overvoltage of the battery 130 has occurred, and whether or not the internal resistance of the battery 130 is equal to or higher than a threshold. Furthermore, the determination section 144 determined whether or not the voltage difference between the batteries 130 is equal to or higher than the threshold, for example, by comparing the voltage difference between the highest voltage and the lowest voltage among the voltages of the batteries 130 with the threshold.

Note that the determination criteria for the presence of an abnormality in the battery 130 are not limited to the above. Furthermore, the threshold of the temperature of the battery 130 and the threshold of the voltage difference between the batteries 130 are not limited to particular values. These thresholds are, for example, predetermined and stored in the memory of the BMU 101.

When the determination section 144 determines that the SOH indicating the state of deterioration in the battery 130 is equal to or higher than the threshold and the battery 130 is not in an abnormal state, the determination section 144 sets a first collection condition as the collection condition. In the present embodiment, the case where the SOH indicating the state of deterioration in the battery 130 is equal to or higher than the threshold and the battery 130 is not in an abnormal state is referred to as a normal state.

Under the first collection condition, the first collection period is set as the collection period. The length of the first collection period is not limited to a particular length, but is set to “1 second” as an example.

Furthermore, under the first collection condition, for example, a voltage, a current, a temperature, a SOH, and a voltage difference between the batteries 130 are set as the types of data to be collected. These types of data are merely examples and the types of data to be collected are not limited to those types. The types of data to be collected under the first collection condition are also referred to as the types of data included in battery information under the first collection condition. The types of data to be collected are also referred to as items of battery information.

Furthermore, when the SOH indicating the state of deterioration in the battery 130 is lower than the threshold or when the battery 130 is in an abnormal state, the determination section 144 sets a second collection condition as the collection condition.

Under the second collection condition, the second collection period shorter than the first collection period is set as the collection period. The length of the second collection period is not limited to a particular length, but is set to “0.5 seconds” as an example. Furthermore, the second collection period is not limited to a single collection period, but may be a plurality of collection periods. In this case, under the second collection condition, a plurality of collection periods, each being shorter than the first collection period, is set as the collection period.

Furthermore, under the second collection condition, more types of data than under the second collection condition are set as the types of data to be collected. Under the second collection condition, for example, a voltage, a current, a temperature, a SOH, a SOC, the presence of dry-up in the battery 130, and a voltage difference between the batteries 130 are set as the types of data to be collected.

As described above, the second collection period is shorter than the first collection period, and the types of data to be collected under the second collection condition are more than the types of data to be collected under the first collection condition. Therefore, when the second collection condition is applied, more types of data are collected with greater frequency than when the first collection condition is applied.

Furthermore, when the collection period or the types of data to be collected is changed by the later-described ECU 102, the determination section 144 sets the collection period or the types of data to be collected that are changed by the ECU 102, as the collection condition.

The acquisition section 141 acquires measured values, such as the voltage, current, and temperature of the battery 130, from the CMU 131, based on the collection condition determined by the determination section 144. More specifically, the acquisition section 141 acquires measured values included in the types of data defined as the collection condition, every collection period defined as the collection condition.

The acquisition section 141 sends the acquired measured values to the calculation section 142, the estimation section 143, and the transmission section 145.

The calculation section 142 calculates values indicating the characteristics of the battery 130, based on the measured values acquired by the acquisition section 141. In the present embodiment, the calculation section 142 calculates the SOH of each of the batteries 130, the SOC of each of the batteries 130, and the voltage difference between the batteries 130. The calculation section 142 sends the calculated SOH, the calculated SOC, and the calculated voltage difference between the batteries 130 to the determination section 144 and the transmission section 145.

The estimation section 143 estimates alternative characteristics of the battery 130, based on the measured values acquired by the acquisition section 141. For example, using an equivalent circuit model, the estimation section 143 calculates various resistances of the battery 130 from the measured values acquired by the acquisition section 141. When the ohmic resistance of the battery 130 is equal to or lower than a threshold, the estimation section 143 estimates that the internal resistance of the battery 130 is equal to or higher than a threshold.

FIG. 4 is a diagram illustrating an example of an equivalent circuit model 132 of the battery 130 according to the present embodiment. The equivalent circuit model 132 is a battery characteristic model of one battery 130. The equivalent circuit model 132 includes an open-circuit voltage V₀, charge transfer resistances R₀, R₁, and R₂, and capacitor components C₁ and C₂. The number of the charge transfer resistances and the number of the capacitor components vary, depending on the battery characteristics of the battery 130. The open-circuit voltage V₀, the charge transfer resistances R₀, R₁, and R₂, and the capacitor components C₁ and C₂ are also referred to as parameters of the equivalent circuit model 132.

The estimation section 143 calculates values of the parameters of the equivalent circuit model 132 from measured values of the voltage and current of the battery 130. For the calculation, a well-known calculation formula can be applied. The presence of the dry-up is an example of the alternative characteristic, and the estimation section 143 may estimate other alternative characteristics of the battery 130.

The estimation section 143 sends out the estimated alternative characteristic to the determination section 144 and the transmission section 145.

The transmission section 145 transmits the battery information collected by the collection section 140 to the outside. In the present embodiment, the transmission section 145 transmits the battery information acquired, calculated, or estimated by the acquisition section 141, the calculation section 142, or the estimation section 143 to the ECU 102 via the in-vehicle network 120.

When the determination section 144 determines that the battery 130 is in an abnormal state, the transmission section 145 transmits an abnormality signal indicating the abnormality to the ECU 102.

When the collection condition is changed, the transmission section 145 transmits the latest collection condition to the ECU 102.

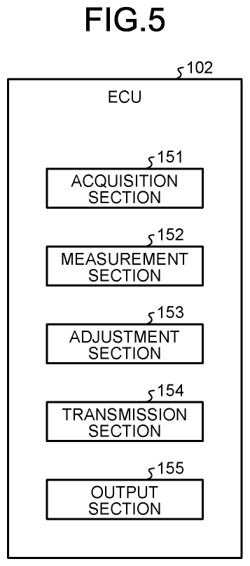

Next, details of the functions of the ECU 102 according to the present embodiment will be described. FIG. 5 is a diagram illustrating an example of the functional configuration of the ECU 102 according to the present embodiment.

As illustrated in FIG. 5, the ECU 102 includes an acquisition section 151, a measurement section 152, an adjustment section 153, a transmission section 154, and an output section 155. The ECU 102 is an example of an external device in the present embodiment.

For example, the acquisition section 151, the measurement section 152, the adjustment section 153, the transmission section 154, and the output section 155 are stored and provided in a memory of the ECU 102, as computer programs in a format executable by a computer. A processor of the ECU 102 reads out and executes the computer programs from the memory, thereby realizing functions corresponding to the above-mentioned sections.

Alternatively, the computer programs executed by the ECU 102 according to the present embodiment may be configured to be stored and provided in a computer-readable storage medium, such as a CD-ROM, a flexible disk, a CD-R, or a DVD, as a file in an installable or executable format. Furthermore, the computer programs executed by the ECU 102 according to the present embodiment may be configured to be stored in a computer connected to a network, such as the Internet, and downloaded and provided via the network. Alternatively, the computer programs executed by the ECU 102 according to the present embodiment may be configured to be provided or distributed via a network, such as the Internet.

Alternatively, the acquisition section 151, the measurement section 152, the adjustment section 153, the transmission section 154, and the output section 155 may be realized in a hardware circuit.

The acquisition section 151 acquires battery information from the BMU 101. The acquisition section 151 sends out the acquired battery information to the adjustment section 153 and the transmission section 154.

Furthermore, when the acquisition section 151 receives an abnormality signal from the BMU 101, the acquisition section 151 sends out the abnormality signal to the output section 155 and the transmission section 154.

The measurement section 152 measures a network load on the in-vehicle network 120. For example, the measurement section 152 measures the volume of data traffic transmitted and received via the in-vehicle network 120 in the vehicle control system 110. In the present embodiment, the volume of data traffic is an example of an index indicating the network load on the in-vehicle network 120. Note that the measurement section 152 may measure the network load on the in-vehicle network 120 with other methods.

Furthermore, the measurement section 152 measures a radio wave state between the TCU 104 and the cloud server device 20. The measurement section 152 sends out the measured volume of data traffic and the radio wave state to the adjustment section 153.

The adjustment section 153 adjusts the collection condition, based on the network load on the in-vehicle network 120 and the radio wave state. More specifically, the adjustment section 153 adjusts the collection period for battery information or the types of data to be collected, based on the volume of data traffic and the radio wave state measured by the measurement section 152.

For example, when the volume of data traffic is higher than a threshold, the adjustment section 153 extends the collection period for battery information and reduces the types of data to be collected. Thus, the adjustment section 153 reduces the network load on the in-vehicle network 120. Also when the radio wave state is unstable, the adjustment section 153 extends the collection period for battery information and reduces the types of data to be collected. Thus, the adjustment section 153 reduces the volume and frequency of data communication between the TCU 104 and the cloud server device 20, and stores the volume and frequency thereof in the memory. Note that the threshold of the volume of data traffic is not limited to a particular value.

The method for the adjustment of the collection condition by the adjustment section 153 is not limited to a particular method. For example, in the case where the first collection condition has been set, when the volume of data traffic is higher than the threshold or the radio wave state is unstable, the adjustment section 153 may change the collection condition from the first collection condition to the second collection condition. Alternatively, the adjustment section 153 may not select either the first collection condition or the second collection condition, but reduce the length of the collection period for battery information or the number of the types of data to be collected.

In contrast, when the volume of data traffic is equal to or lower than the threshold and the radio wave state is stable, the adjustment section 153 does not change the collection period for battery information or the types of data to be collected. Alternatively, when the volume of data traffic is equal to or lower than the threshold and the radio wave state is stable, the adjustment section 153 may shorten the collection period for battery information or increase the types of data to be collected.

When the adjustment section 153 changes the collection period for battery information or the types of data to be collected, then the adjustment section 153 sends out, to the transmission section 154, the changed collection period for battery information or the changed types of data to be collected.

The transmission section 154 transmits battery information acquired from the BMU 101 by the acquisition section 151 to the cloud server device 20.

When the collection condition is adjusted by the adjustment section 153, the transmission section 154 transmits the types of data based on the adjusted collection condition to the cloud server device 20 with a period based on the adjusted collection condition. For example, when the volume of data traffic is higher than the threshold, a load on the in-vehicle network 120 is high, and accordingly the transmission section 154 transmits battery information to the cloud server device 20 via the CGW 103 and the TCU 104 at the timing corresponding to the collection period extended by the adjustment section 153, and thereby reduces the frequency of transmission.

Furthermore, when the collection condition is adjusted by the adjustment section 153, the transmission section 154 transmits the adjusted collection condition to the BMU 101.

Furthermore, when the acquisition section 151 receives an abnormality signal from the BMU 101, the transmission section 154 transmits the abnormality signal to the cloud server device 20. Note that the transmission section 154 may convert the format of the abnormality signal received from the BMU 101 into a data format readable by the cloud server device 20, and then transmit the signal.

When the acquisition section 151 receives an abnormality signal from the BMU 101, the output section 155 outputs an image or audio that notifies a driver or the like of an abnormality in the battery 130.

For example, the output section 155 transmits an abnormality signal to the IVI 105 to cause the IVI 105 to control a monitor and a loudspeaker installed in the vehicle 10, whereby an image or audio is outputted. Alternatively, the output section 155 may control the monitor and the loudspeaker installed in the vehicle 10 to output an image or audio.

Alternatively, for example, using a mirroring technique, the output section 155 may output an image or audio that notify a driver or the like of an abnormality in the battery 130, to an information telecommunications terminal, such as a smartphone, of the driver or a fellow passenger in the vehicle 10.

The image or audio that notifies a driver or the like of an abnormality is specifically, for example, a message or audio describing the nature of the abnormality, such as “the temperature of a battery has risen” or “the internal resistance of a battery is possibly equal to or higher than the threshold”. Information capable of specifying the nature of abnormalities shall be included in an abnormality signal. Alternatively, the image or audio that notifies a driver or the like of an abnormality may be simply a warning sign and a warning beep.

Next, the flow of battery information management processing executed by the battery information management system S configured as described above according to the present embodiment will be described.

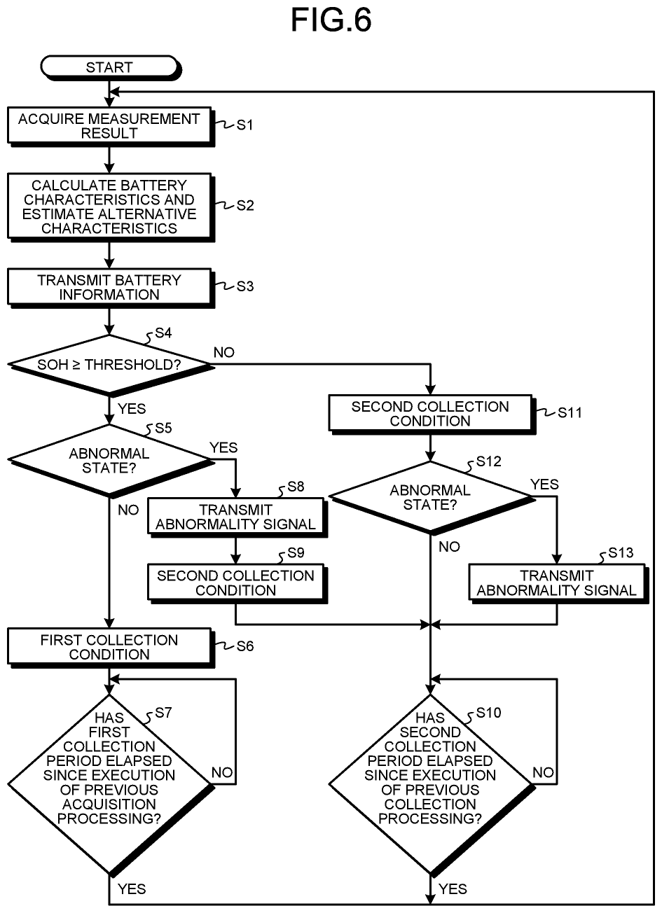

FIG. 6 is a flowchart illustrating an example of the flow of processing executed in the BMU 101 according to the present embodiment. The processing in the flowchart is started, for example, when the power of the vehicle 10 is turned on. Furthermore, the first collection condition shall have been set as of the start of this flowchart.

First, the acquisition section 141 acquires measured values included in the types of data defined as the first collection condition from the CMU 131 (S1). For example, when the types of data defined as the first collection condition are a voltage, a current, a temperature, a SOH, and a voltage difference between the batteries 130, the acquisition section 141 acquires the voltage, the current, and the temperature of each of the batteries 130 from the CMU 131.

Then, based on the measured values acquired by the acquisition section 141, the calculation section 142 calculates value indicating characteristics of the batteries 130 included in the types of data defined as the first collection condition. Furthermore, based on the measured value acquired by the acquisition section 141, the estimation section 143 estimates alternative characteristics of the batteries 130 included in the types of data defined as the first collection condition (S2). For example, the calculation section 142 calculates a SOH, based on the voltage and the current acquired by the acquisition section 141. Alternatively, the calculation section 142 calculates a voltage difference between the batteries 130, based on the voltages acquired by the acquisition section 141.

When data found by the estimation are not included in the types of data defined as the already-set collection condition, the estimation section 143 does not execute estimation processing.

Subsequently, the transmission section 145 transmits the battery information acquired, calculated, or estimated by the acquisition section 141, the calculation section 142, and the estimation section 143, to the ECU 102 via the in-vehicle network 120.

The determination section 144 determines whether or not the SOH calculated by the calculation section 142 is equal to or higher than a threshold (S4). For example, the determination section 144 determines whether or not the lowest value among SOHs of the batteries 130 is equal to or higher than the threshold.

When the SOH calculated by the calculation section 142 is equal to or higher than the threshold (“Yes” at S4), the determination section 144 determines that the battery 130 has not deteriorated.

In this case, the determination section 144 determines whether or not the battery 130 is in an abnormal state, based on the battery information (S5).

In the example in this flowchart, the types of data defined as the current collection condition, namely, the first collection condition, are a voltage, a current, a temperature, a SOH, and a voltage difference between the batteries 130. Therefore, for example, when the temperature of the battery 130 is equal to or higher than the threshold, when an overvoltage of the battery 130 has occurred, or when the voltage difference between the batteries 130 is equal to or higher than the threshold, the determination section 144 determines that the battery 130 is in an abnormal state (“Yes” at S5). Furthermore, in the case where the presence of dry-up in the battery 130 is included in the data to be collected, when the internal resistance of the battery 130 is equal to or higher than a threshold, the determination section 144 determines that the battery 130 is in an abnormal state.

In contrast, when the temperature of the battery 130 is lower than the threshold, when an overvoltage of the battery 130 has not occurred, or when the voltage difference between the batteries 130 is lower than the threshold, the determination section 144 determines that the battery 130 is not in an abnormal state (“No” at S5). In this case, the determination section 144 sets the first collection condition as the collection condition (S6). In the example in this flowchart, the first collection condition has been already set, and accordingly, the determination section 144 determines not to change the collection period and the types of data to be collected.

Next, the acquisition section 141 determines whether or not the first collection period has elapsed since the execution of the previous acquisition processing (S7). When the acquisition section 141 determines that the first collection period has not elapsed (“No” at S7), the acquisition section 141 repeats the processing of S7 and stands by.

In contrast, when the acquisition section 141 determines that the first collection period has elapsed (“Yes” at S7), the step returns to the processing of S1, and the acquisition section 141 acquires measured values included in the types of data defined as the first collection condition from the CMU 131.

When the determination section 144 determines that the battery 130 is in an abnormal state through the processing of S5, the transmission section 145 transmits an abnormality signal indicating an abnormality in the battery 130 to the ECU 102 (S8).

In this case, the determination section 144 sets the second collection condition (S9). When the first collection condition is changed to the second collection condition, the collection period is changed to the second collection period, which is shorter than the first collection period. Furthermore, the number of types of data to be acquired exceeds the number of types of data under the first collection condition. In the example in this flowchart, under the second collection condition, the presence of dry-up in the battery 130 is set as a target to be collected in addition to the types of data to be acquired under the first collection condition.

Next, the acquisition section 141 determines whether or not the second collection period has elapsed since the execution of the previous acquisition processing (S10). When the acquisition section 141 determines that the second collection period has not elapsed (“No” at S10), the acquisition section 141 repeats the processing of S10 and stands by.

In contrast, when the acquisition section 141 determines that the second collection period has elapsed (“Yes” at S10), the step returns to the processing of S1. From this point onward, processing is executed based on the second collection condition.

When the SOH calculated by the calculation section 142 is lower than the threshold (“Yes” at S4), the determination section 144 determines that the battery 130 has deteriorated. In this case, the determination section 144 sets the second collection condition (S11).

Next, the determination section 144 determines whether or not the battery 130 is in an abnormal state, based on the battery information (S12). The processing for determining whether or not the battery 130 is in an abnormal state is the same as the processing of S5.

When the determination section 144 determines that the battery 130 is in an abnormal state (“Yes” at S12), the transmission section 145 transmits an abnormality signal indicating an abnormality in the battery 130 to the ECU 102 (S13). Then, the step proceeds to the processing of S10, so that the acquisition section 141 determines whether or not the second collection period has elapsed since the execution of the previous acquisition processing.

Also when the determination section 144 determines that the battery 130 is not in an abnormal state (“No” at S12), the step proceeds to the processing of S10, so that the acquisition section 141 determines whether or not the second collection period has elapsed since the execution of the previous acquisition processing.

The processing in the flowchart shall be continuously executed as long as the power of the vehicle 10 is turned on, for example.

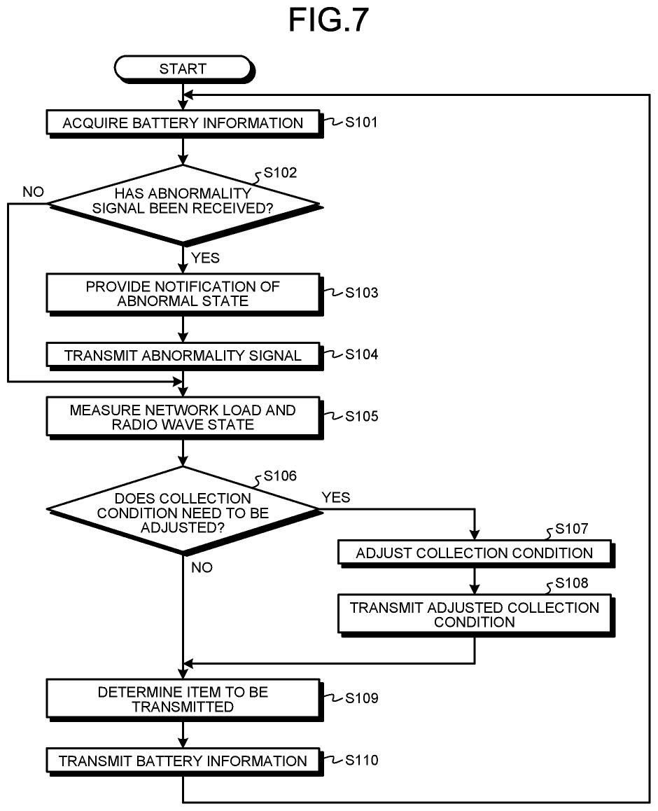

Next, the flow of processing executed in the ECU 102 according to the present embodiment will be described. FIG. 7 is a flowchart illustrating an example of the flow of the processing executed in the ECU 102 according to the present embodiment.

The acquisition section 151 acquires battery information from the BMU 101 (S101). The acquisition section 151 sends the acquired battery information to the adjustment section 153 and the transmission section 154.

Furthermore, the acquisition section 151 determines whether or not an abnormality signal has been received from the BMU 101 (S102). When the acquisition section 151 determines that the abnormality signal has been received (“Yes” at S102), the acquisition section 151 sends the abnormality signal to the output section 155 and the transmission section 154.

Then, based on the abnormality signal acquired by the acquisition section 151, the output section 155 outputs an image or audio to notify a driver or the like that the battery 130 is in an abnormal state (S103).

Next, the transmission section 154 transmits the abnormality signal acquired by the acquisition section 151 to the cloud server device 20 (S104).

Next, the measurement section 152 measures a network load on the in-vehicle network 120. Furthermore, the measurement section 152 measures a radio wave state between the TCU 104 and the cloud server device 20 (S105). The measurement section 152 sends a measurement result to the adjustment section 153.

When the acquisition section 151 determines that the abnormality signal has not been received (“No” at S102), the step proceeds to the processing of S105.

Then, based on the network load and the radio wave state measured by the measurement section 152, the adjustment section 153 determines whether or not the collection condition needs to be adjusted (S106).

For example, when the network load is higher than a threshold or when the radio wave state is unstable, the adjustment section 153 determines that the collection condition needs to be adjusted (“Yes” at S106). In this case, the adjustment section 153 adjusts the collection condition (S107). When the collection condition is adjusted by the adjustment section 153, the transmission section 154 transmits the adjusted collection condition to the BMU 101 (S108). The processing of S108 is followed by the processing of S109.

When the adjustment section 153 determines that the collection condition does not need to be adjusted (“No” at S106), the step proceeds to the processing of S109 without executing the processing of S107 and S108.

Next, the transmission section 154 transmits battery information to the cloud server device 20 (S110). When the collection condition is adjusted by the adjustment section 153, the transmission section 154 transmits a period and battery information on data items based on the adjusted collection condition to the cloud server device 20.

The processing in this flowchart shall be continuously executed as long as the power of the vehicle 10 is turned on, for example.

As described above, when the degree of deterioration of the battery 130 is lower than the reference, the BMU 101 according to the present embodiment collects battery information with the first collection period, meanwhile, when the degree of deterioration of the battery 130 is equal to or higher than the reference, the BMU 101 collects battery information with the second collection period shorter than the first collection period, and transmits the collected battery information to the ECU 102. Thus, the BMU 101 according to the present embodiment distinguishes the frequency of acquiring battery information in the normal state in which the battery 130 has not deteriorated from the frequency of acquiring battery information in a state in which the battery 130 has deteriorated, so that, by reducing the frequency of acquiring battery information in the normal state, the volume of data traffic associated with battery management can be reduced.

Furthermore, when the degree of deterioration of the battery 130 is equal to or higher than the reference, the BMU 101 according to the present embodiment collects battery information with the second collection period shorter than the first collection period, and thereby can monitor with higher precision after the deterioration of the battery 130 than in the normal state.

Furthermore, when the degree of deterioration of the battery 130 is lower than the reference, the BMU 101 according to the present embodiment collects a plurality of types of data defined as the collection condition, meanwhile, when the degree of deterioration of the battery 130 is equal to or higher than the reference, the BMU 101 collects more types of data than when the degree of deterioration of the battery 130 is lower than the reference. Thus, by reducing the data volume of battery information in the normal state, the BMU 101 according to the present embodiment can further reduce the volume of data traffic associated with the battery management.

Furthermore, by reducing the frequency of collecting battery information in the normal state and the types of data, the BMU 101 according to the present embodiment can reduce the data volume of battery information to be stored in the cloud server device 20.

Furthermore, based on the battery information, the BMU 101 according to the present embodiment determines whether or not the battery 130 is in an abnormal state. When the BMU 101 determines that the battery is in an abnormal state, the BMU 101 collects the battery information with the second collection period. Thus, when an abnormality occurs, the BMU 101 according to the present embodiment can shorten the collection period for battery information to perform monitoring with higher precision than in the normal state.

When the battery 130 is not in an abnormal state, the BMU 101 according to the present embodiment collects a plurality of types of data defined as the collection condition, meanwhile, when the battery 130 is in an abnormal state, the BMU 101 collects more types of data than when the battery 130 is not in an abnormal state. Thus, when an abnormality occurs, the BMU 101 according to the present embodiment can monitor the state of the battery 130 in more detail.

When the battery 130 is in an abnormal state, the BMU 101 according to the present embodiment changes the types of data to be collected. Thus, the BMU 101 according to the present embodiment can perform monitoring in accordance with the state of the battery 130 by collecting different types of data between in the normal state and in the abnormal state.

Furthermore, when the BMU 101 according to the present embodiment determines that the battery 130 is in an abnormal state, the BMU 101 outputs the nature of the abnormal state. Thus, the BMU 101 according to the present embodiment can, for example, cause a driver of the vehicle 10 equipped with the battery 130 to grasp the abnormal state of the battery 130 and urge the driver to perform maintenance.

Note that, in the present embodiment, the ECU 102 is a VCU that controls the entirety of the vehicle 10, but the ECU 102 may not be the VCU, but be an ECU designed specifically for controlling the battery 130.

The vehicle 10 is not limited to an electric vehicle, but may be a hybrid car, for example.

In the present embodiment, the ECU 102 is configured to transmit battery information and an abnormality signal to the cloud server device 20, but may be configured to transmit battery information and an abnormality signal directly, for example, to the delivery terminal 301, the information processing terminal 401 owned by the user 40, or the server device 50, by bypassing the cloud server device 20.

In the present embodiment, each of the batteries 130a to 130n is regarded as an example of a battery, but, each of the batteries 130a to 130n may be referred to as a “cell” and a combination of the batteries 130a to 130n may be referred to as a “battery.”

Some of the functions described as functions executed by the BMU 101 in the present embodiment may be executed by the CMU 131 or the ECU 102.

For example, in the present embodiment, the BMU 101 is configured to calculate a SOH and a SOC, but the CMU 131 may be configured to calculate a SOH or a SOC. In the case where the above-mentioned configuration is employed, the acquisition section 141 of the BMU 101 acquires a SOH or a SOC from the CMU 131, together with the measurement results of a voltage, a current, a temperature, and the like.

The ECU 102 may have the functions of the calculation section 142, the estimation section 143, and the determination section 144 of the BMU 101. Furthermore, the functions of the ECU 102 may be executed by the BMU 101 or the CMU 131.

In the present embodiment, a collection period and data items to be collected are changed in two steps, that is, under the first collection condition and under the second collection condition. However, every time the deterioration of the battery 130 progresses, the collection period may be shortened step by step or the number of data items may be increased step by step. For example, every time the deterioration of the battery 130 progresses, the number of parameters to be calculated among the parameters of an equal circuit may be increased.

The scan frequency for the battery 130 by the CMU 131 may be different between under the first collection condition and under the second collection condition. For example, when the degree of deterioration of the battery 130 is lower than a reference or when the battery 130 is in an abnormal state, the CMU 131 may make the scan frequency higher than in the normal state, and measure the voltage and current of the battery 130 in more detail than in the normal state.

### Second Embodiment

In the above-described first embodiment, a plurality of batteries 130 are provided per BMU 101, but, the configuration of the battery and the BMU is not limited to this configuration. For example, in a second embodiment, the ratio of a battery to the BMU to be provided is 1 to 1.

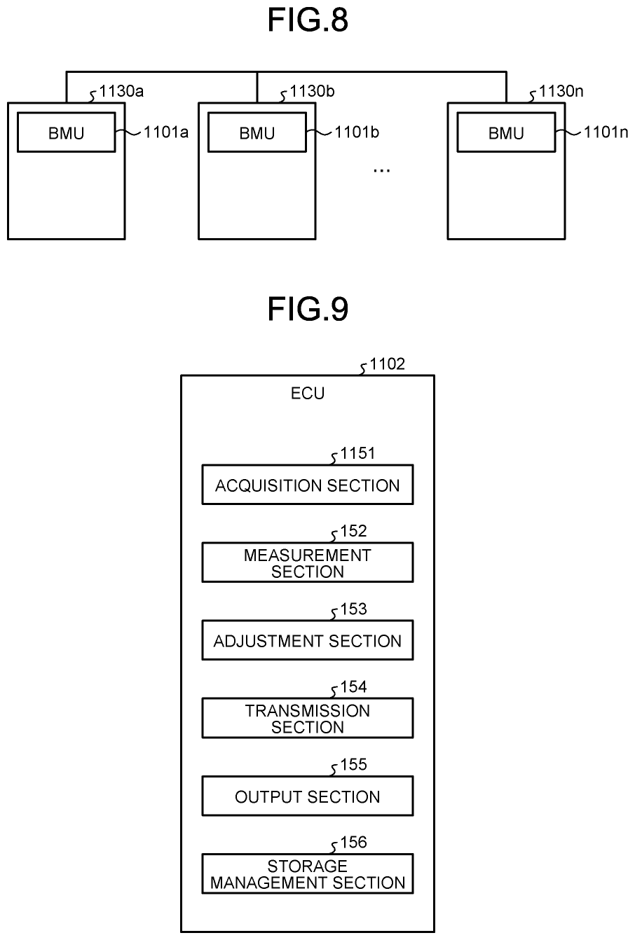

FIG. 8 is a diagram illustrating an example of a configuration of BMUs 1101a to 1101n and batteries 1130a to 1130n according to the present embodiment. As illustrated in FIG. 8, each of the batteries 1130a to 1130n is provided in a corresponding one of the BMUs 1101a to 1101n according to the present embodiment. In the case of applying this configuration, no CMU is provided.

The BMUs 1101a to 1101n according to the embodiment have both the functions of the BMU in the first embodiment and the functions of the CMU 131 in the first embodiment.

### Third Embodiment

In the above-described first and second embodiments, battery information is stored in the cloud server device 20, but, a place for storing battery information is not limited to the cloud server device 20. For example, in a third embodiment, a blockchain is used to store battery information in a plurality of information processing devices on a network.

FIG. 9 is a diagram illustrating an example of the functional configuration of an ECU 1102 according to the present embodiment. As illustrated in FIG. 9, the ECU 1102 according to the present embodiment includes an acquisition section 1151, a measurement section 152, an adjustment section 153, a transmission section 154, an output section 155, and a storage management section 156. The measurement section 152, the adjustment section 153, the transmission section 154, and the output section 155 have the same functions as those in the first embodiment. In the present embodiment, the ECU 1102 is an example of a battery information management device.

With the same function as that in the first embodiment, the acquisition section 1151 according to the present embodiment acquires a state of the vehicle 10. The state of the vehicle 10 includes, for example, the speed or acceleration of the vehicle 10. The state of the vehicle 10 may further include information on operations, such as sudden braking and steering at a sharp angle.

The storage management section 156 stores battery information and the state of the vehicle 10 acquired by the acquisition section 1151 in association with each other in a plurality of external devices.

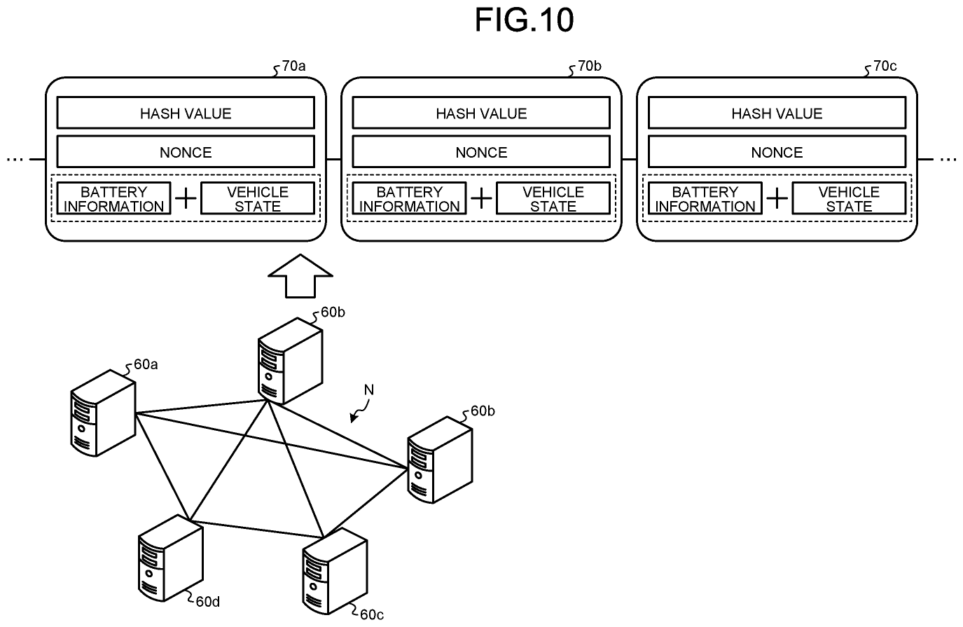

FIG. 10 is a diagram illustrating an example of a storage format of battery information and the state of the vehicle 10 according to the present embodiment. As illustrated in FIG. 10, the storage management section 156 unites battery information, the state of the vehicle 10, a hash value, and nonce in association with each other into one block 70a, and using blockchain techniques, the block 70a is stored in a plurality of information processing devices 60a to 60d connected with the TCU 104 via a network N. The blocks 70a to 70c are blocks, for example, in which a plurality of pieces of battery information collected on a time-series basis is respectively associated with the states of the vehicle 10 as of the acquisition of the pieces of battery information.

The hash value is a value obtained by transforming the battery information and the vehicle 10 with the hash function. The network N is a network such as the Internet.

The information processing devices 60a to 60d may be server devices or PCs, for example. The information processing devices 60a to 60d connected via the network N are examples of external devices in the present embodiment.

Thus, according to the present embodiment, battery information and the state of the vehicle 10 are stored in association with each other in the external devices, whereby the backup redundancy and storage of a large amount of past battery information and the state of the vehicle 10 can be accomplished.

Note that the battery information and the state of the vehicle 10 may be stored in association with each other in the cloud server device 20. Further, the storage management section 156 may not be a function of the ECU 1102, but be a function of the cloud server device 20.

First Modification

In the above-described first and second embodiments, the BMU 101 serves as an example of a battery information management device, but the ECU 102 may serve as an example of the battery information management device. In the case of employing the above-mentioned configuration, the acquisition section 151 of the ECU 102 serves as an example of a collection section. In this case, the cloud server device 20 serves as an example of an external device.

Alternatively, the BMU 101 and the ECU 102 may be collectively referred to and serve as an example of the battery information management device. Alternatively, the vehicle control system 110 may serve as an example of the battery information management device. Alternatively, the cloud server device 20 may have a function of the battery information management device.

Second Modification

In the above-described first to third embodiments, the BMU 101 changes the period for collecting battery information and the items to be collected in accordance with a SOH, but a configuration may be employed in which a period for collecting battery information from the CMU 131 by the BMU 101 is not changed, meanwhile, a period for transmitting battery information to the ECU 102 by the BMU 101 and battery information items to be transmitted are changed in accordance with a SOH.

In the case of employing the above-mentioned configuration, a period with which the BMU 101 transmits battery information to the ECU 102 is referred to as a collection period, meanwhile battery information items to be transmitted to the ECU 102 by the BMU 101 are referred to as collection items.

Third Modification

In the above-described first to third embodiments, when the battery 130 is in an abnormal state, a notice is displayed on a monitor of the vehicle 10, a driver's smartphone, or the like, but notice of an abnormality is not limited to the above. For example, the cloud server device 20 may display an abnormality received from the ECU 102 on the delivery terminal 301 provided in the delivery company 30.

Fourth Modification

In the above-described first to third embodiments, the collection section 140 may be configured to collect data in the second collection period before the use of the battery 130 and immediately after the use of the battery 130. In this case, after the passage of a predetermined period following the start of the use, if the degree of deterioration of the battery 130 is lower than the reference, the collection section 140 changes the collection period and the types of data to be collected, in accordance with the presence of an abnormality in the battery 130. For example, when the degree of deterioration of the battery 130 is lower than the reference and the battery 130 is not in an abnormal state, the collection section 140 collects battery information with the first collection period. When the battery 130 is in an abnormal state, the collection section 140 collects battery information with the second collection period shorter than the first collection period.

Some embodiments according to the present invention were described. These embodiments are merely examples, and are not intended to limit the scope of the invention. These embodiments can be realized in other various forms, and can be variously omitted, replaced, and modified without departing from the spirit of the present invention. These embodiments and modifications thereof are included in the scope and abstract of the invention, and also included in the invention described in the scope of claims and the range of equivalency.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A battery information management device comprising:
a memory; and
a hardware processor coupled to the memory,
the hardware processor being configured to:
when a degree of deterioration of a battery is lower than a reference, collect battery information on the battery with a first collection period;
when the degree of deterioration of the battery is equal to or higher than the reference, collect the battery information with a second collection period shorter than the first collection period; and
transmit the collected battery information to an external device.

2. The battery information management device according to claim 1, wherein the hardware processor is configured to:
when the degree of deterioration of the battery is lower than a reference, collect a plurality of types of data defined as a collection condition; and
when the degree of deterioration of the battery is equal to or higher than the reference, collect more types of data than when the degree of deterioration of the battery is lower than the reference.

3. The battery information management device according to claim 1, wherein the hardware processor is further configured to determine whether or not the battery is in an abnormal state, based on the collected battery information, and
the hardware processor is configured to collect the battery information with the second collection period, when determining that the battery is in the abnormal state.

4. The battery information management device according to claim 1, wherein hardware processor is configured to:
when the battery is not in an abnormal state, collect a plurality of types of data defined as a collection condition; and
when the battery is in the abnormal state, collect more types of data than when the battery is not in the abnormal state.

5. The battery information management device according to claim 1, wherein the hardware processor is configured to change a type of data to be collected, when the battery is in an abnormal state.

6. The battery information management device according to claim 3, wherein the hardware processor is further configured to output a nature of the abnormal state and the battery information, when determining that the battery is in the abnormal state.

7. The battery information management device according to claim 1, wherein the battery information includes at least one of a voltage, a current, and a temperature of the battery.

8. The battery information management device according to claim 1, wherein
the battery is installed in a vehicle, and
the hardware processor is further configured to store the battery information and a state of the vehicle in association with each other in a plurality of external devices.

9. A battery information management method comprising:
collecting battery information on a battery with a first collection period, when a degree of deterioration of the battery is lower than a reference;
collecting the battery information with a second collection period shorter than the first collection period, when the degree of deterioration of the battery is equal to or higher than the reference; and
transmitting the battery information collected at the collection step to an external device.

10. A battery information management system comprising:
a battery information management device;
a control device; and
a storage device,
the battery information management device including:
a memory; and
a hardware processor coupled to the memory,
the hardware processor being configured to:
when a degree of deterioration of a battery is lower than a reference, collect battery information on the battery with a first collection period;
when the degree of deterioration of the battery is equal to or higher than the reference, collect the battery information with a second collection period shorter than the first collection period; and
transmit the collected battery information to an external device,
the control device including:
a second memory; and
a second hardware processor coupled to the memory, the second hardware processor being configured to:
adjust a collection period for the battery information, in accordance with a load on a network connecting the battery information management device and the control device; and
transmit the battery information acquired from the battery information management device to the storage device,
the storage device being configured to store the battery information transmitted from the control device.
